(19) United States
(12) Patent Application Publication
(10) Pub. No.: US 2005/0072364 A1
(43) Pub. Date: Apr. 7, 2005

(54) Pet rest and recreation apparatus

(76) Inventor: Nancy C. Kerrigan, Woburn, MA (US)

Correspondence Address: Todd S. Parkhurst;Holland & Knight LLC, 30th Floor, 131 South Dearborn St., Chicago, IL, 60603, US

(21) Appl. No.: 10/677,576

(22) Filed: Oct. 2, 2003

(51) Int. Cl. A01K 1/035

(52) U.S. Cl. 119/28.5

(57) ABSTRACT

A pet rest and recreation apparatus is disclosed which provides a clean, relaxing and fun space for a pet. The pet rest and recreation apparatus comprises a storage space with a door, steps, adjacent to the storage space, which lead to a rest area. In the preferred exemplary embodiment, the rest area is atop the storage space. Finally, the rest area is sufficiently elevated to allow a pet to look outside a window.

### BACKGROUND OF THE INVENTION

1. Field of the Invention

The present invention relates, in general, to the field of pet care. More specifically, the present invention is directed to a pet bed that provides a complete storage and sleep system.

2. Description of the Related Art

The present invention overcomes the shortcomings and the deficiencies of the prior art and is directed to an apparatus which solves or at least substantially reduces the impact of these problems associated with existing pet beds.

Currently, advances in pet care have resulted in the production and distribution of various dietary formulas and tools to ensure a pet's total well being. In order to provide a healthy and caring environment, pet beds have been sold by manufacturers and pet shops. Cushions, baskets with pads and pens are currently utilized as pet beds.

Such conventional systems provide many advantages because they provide thermal protection during sleep or rest. Additionally, they provide protection from bone and skin conditions by providing a soft surface during rest. However, conventional pet beds are ill suited for providing total well being.

One significant deficiency of conventional pet beds is that they do not provide any storage for various pet goods. As a result, various pet items such as toys and food items are strewn about the pet bed. This creates unsanitary conditions which are detrimental to a pet's health, especially given the sensitivity of most pets. Additionally, this creates an unappealing area in which pet gods are scattered thereby requiring time and resources for continual cleaning.

Another deficiency of existing pet beds is that they do not allow the pet to enjoy its surroundings. Pets prefer to view the outside environment by looking out a window during their rest or leisure. In fact, many pets not only gain enjoyment by looking outside windows while their masters are out but they also prefer to look and wait for their masters' arrival. Additionally, most pets use windowsills and furniture backing as seats and ledges to view the external environment. Consequently, furniture is damaged and must be repaired or even replaced.

Finally, conventional pet beds provide relatively small resting areas. As a result, pets are often uncomfortable and prefer to rest and/or sleep on other furniture.

The present invention overcomes the shortcomings and deficiencies of the prior art and is directed to systems and methods which solve or at least substantially reduce the impact of these problems associated with existing pet beds.

One object and advantage of the present invention is to provide a pet bed that stores pet materials and accessories.

It is another object and advantage of the present invention to provide a pet bed which provides a comfortable play and sleep space.

It is further an object and advantage of the present invention to provide a pet rest apparatus which entertains the pet.

The above and other objects, advantages, and features of the present invention will become readily appreciated and understood from consideration of the following detailed description of the preferred embodiment of the present invention when taken together with the accompanying drawings of the present invention.

### SUMMARY OF THE INVENTION

In accordance with the foregoing objects, the present invention comprises an apparatus for storing pet accessories and providing a comfortable playing and sleeping space. In accordance with a preferred exemplary embodiment of the present invention, there is provided a pet bed having a storage space such as a closet and a sleeping and playing area. The sleeping and playing area is sufficiently large to allow the pet bed to comfortably move about in the bed. Moreover, in the preferred exemplary embodiment, the pet bed is sufficiently elevated so as to allow a pet to view outside through a window.

### BRIEF DESCRIPTION OF THE DRAWINGS

FIG. 1. is an isometric view of the pet bed;

FIG. 2. is a front elevational view of the present invention;

FIG. 3. is a back elevational view of the present invention;

FIG. 4. is a right side view of the present invention;

FIG. 5. displays the right side view of FIG. 4 but without a side panel;

FIG. 6. presents a left side view of the pet bed;

FIG. 7. provides a top plan view of the present invention;

### DETAILED DESCRIPTION OF THE INVENTION

While various embodiments of the present invention are discussed in detail below, it should be appreciated that the present invention provides inventive concepts that can be embodied in a wide variety of specific contexts. The specific embodiments discussed are merely illustrative of specific ways to make and use the invention and do not limit the scope of the invention.

Turning first to FIG. 1, there is shown a preferred exemplary embodiment of the present invention, generally a pet sleep and rest apparatus 10. It is comprised of wood or board, however, any material that forms a substantially rigid frame may be utilized. As a result, the pet bed provides a defined area in which the pet can play or rest. Moreover, even though a rectangular pet bed 10 is displayed, a person of ordinary skill in the art will appreciate that various shapes can be utilized.

The pet bed 10 further comprises a storage area 11 for storing pet items such as toys, food, grooming supplies and clothes. In the preferred exemplary embodiment, the storage area 11 comprises a closet that is accessible by a door 12. The door 12 may comprise an ornamental design or a simple sliding or opening door. Hence, various items can be hidden in the storage area 11 and a clean, sanitary environment may be maintained around the pet bed 10. Therefore, the pet can play in a clean and safe environment which not only promotes the health and well being of the pet but also provides a well maintained and appealing area around the pet bed.

In addition, the pet bed 10 comprises a rest/sleep space 13. In the preferred exemplary embodiment, the rest space 13 is located over the storage area 11. Furthermore, the rest space 13 is large enough to comfortably allow a pet to lie or sit in. The present invention contemplates that pet beds of various sizes may be designed for pets of various sizes. This allows a pet to have a personal and comfortable space. Furthermore, the rest space 13 is covered by any material which may provide a comfortable sleeping area. For example, a carpet, a mattress pad, or another comfortable surface may be provided. The same material or different materials may be utilized for the floor 14 and sides 15 of the rest area 13. Therefore, a mattress pad may be laid on the floor 14 while carpet is used as the cover for sides 15. The sides 15 provide a boundary around the floor 14 to prevent the pet from falling off the pet bed. Additionally, different materials that provide various textures and different degrees of firmness may be utilized.

Finally, in the preferred exemplary embodiment, the pet bed 10 comprises steps 16 leading to the rest area 13. In the preferred exemplary embodiment the steps 16 are adjacent to the storage area 11. The pet bed 10 is preferably sufficiently elevated to allow a pet to view outside a window when the pet bed 10 is placed in from of a window. Although steps are provided in the exemplary preferred embodiment, ramps, platforms and other such structure may be used. Hence, there is provided a pet bed 10 that permits the pet to view the external environment.

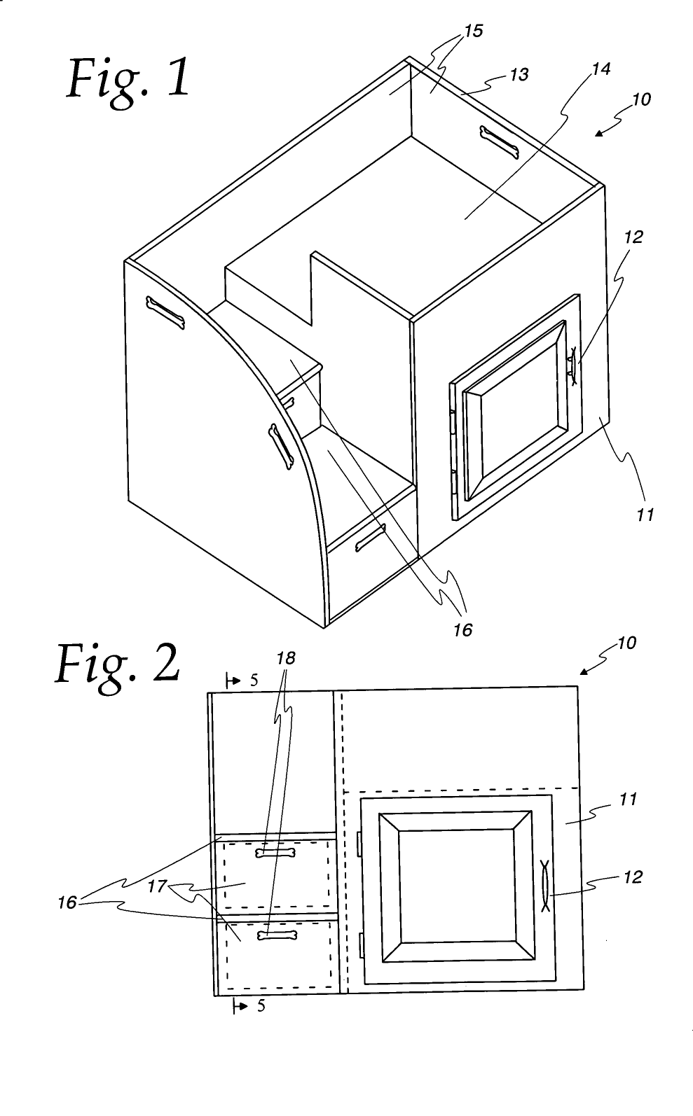

In FIG. 2, the ornamental door 12 for storage area 11 is distinctly presented. The figure also discloses that the steps 16 comprise drawers 17 which can be used as additional storage space. Handles 18 are used to open and access drawers 17. Although sliding drawers are utilized by the preferred embodiment, other space covers may be used. FIG. 2 discloses that two steps 16 are utilized, however, one or more steps may be used to reach the rest space 13.

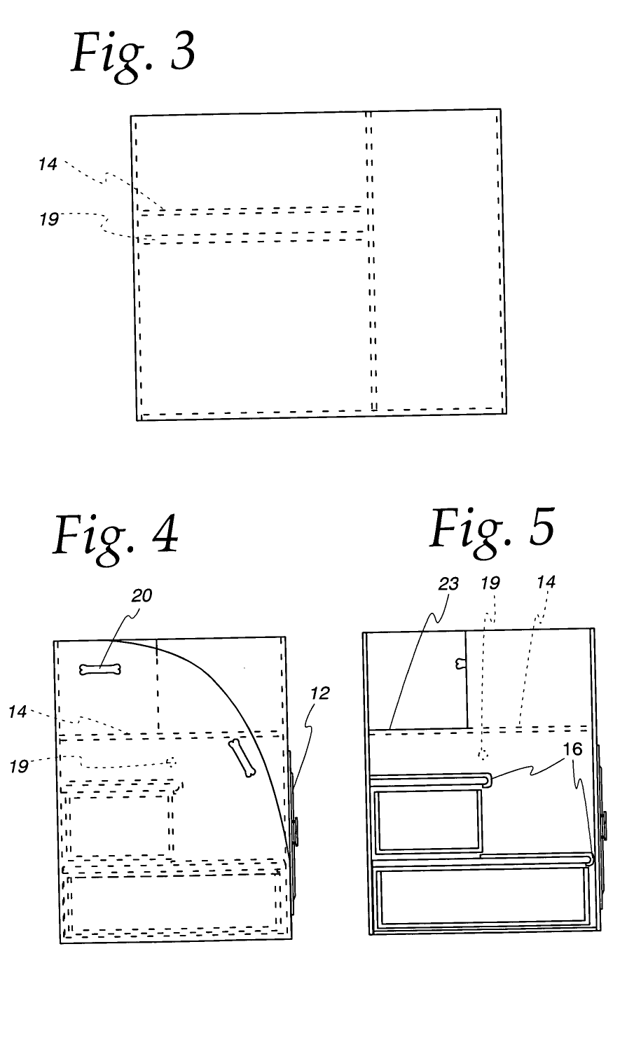

FIG. 3 discloses a back view of the pet bed 10. The figure discloses that in the preferred exemplary embodiment, the closet 11 includes a pole 19 for hanging pet clothes and other items. The pole 19 is situated below the bed floor 14.

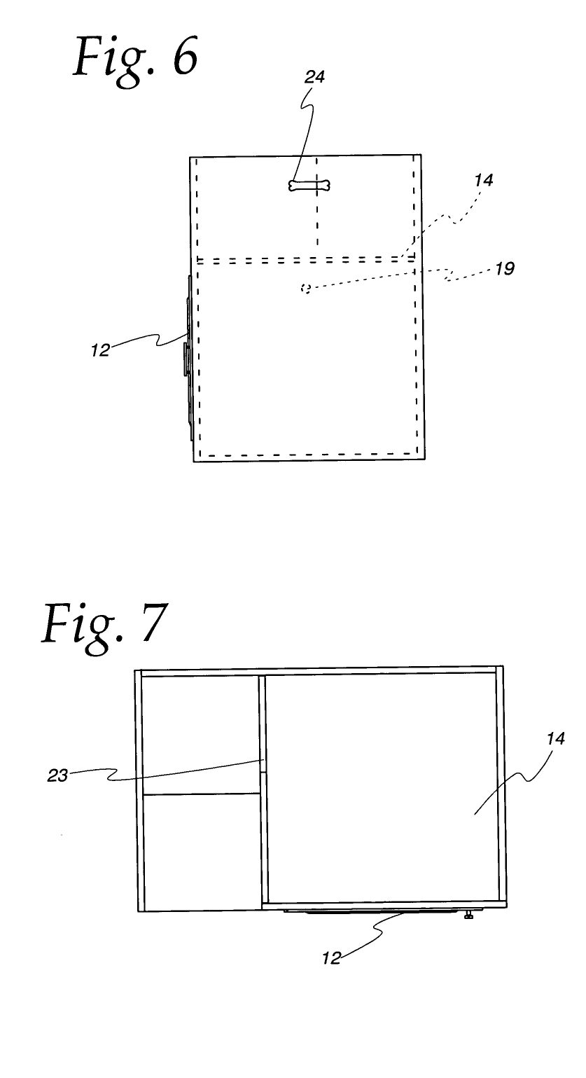

Turning next to FIG. 4, a right side elevational view is presented. The right side 21 comprises a handle 20. A corresponding handle 22 is also provided on the left side as disclosed in FIG. 6. The handles are used to move and carry the pet bed. Thus, the present invention provides a pet bed that may be easily transported.

FIG. 5 displays the same view as FIG. 4 but without the side 21. A third step 23 is disclosed which leads to the floor 14. Additionally, FIG. 6 discloses a left handle 24 on the left side of the pet bed. Finally, the layout according to a preferred exemplary embodiment of floor 14 is shown in FIG. 7.

The specific embodiments discussed in the detailed description are merely illustrative of specific ways to make and use the invention, and do not limit the scope of the invention.

1. A pet rest and recreation apparatus comprising, in combination,
a storage area;
a rest space; and
steps to said rest space adjacent to said storage area.

2. A pet rest and recreation apparatus as in claim 1 where said rest space is elevated to allow a pet to view outside a window and is located atop said storage area.

3. A pet rest and recreation apparatus as in claim 2 where said storage space is a closet.

4. A pet rest and recreation apparatus as in claim 1 where said rest space is surrounded by sides and said sides comprise handles.

5. A pet rest and recreation apparatus as in claim 1 where said steps partly define storage space.

6. A pet rest and recreation apparatus as in claim 1 where said rest space includes a mattress pad.

7. A pet rest and recreation apparatus as in claim 1 where said steps and said rest area are covered in carpet.

8. A pet rest and recreation apparatus comprising, in combination,
a closet;
a rest space atop the closet where said rest space is elevated sufficiently to allow a pet to view outside a window; and
steps to said rest space adjacent to the closet.

9. A pet rest and recreation apparatus as in claim 8 where said rest space is surrounded by sides and said sides comprise handles.

10. A pet rest and recreation apparatus as in claim 8 where said steps include storage space.

11. A pet rest and recreation apparatus as in claim 8 where said rest space includes a mattress.

12. A pet rest and recreation apparatus as in claim 8 where said steps and said rest area are covered in carpet.

13. A pet rest and recreation apparatus as in claim 8 where said steps are covered in carpet and said rest space includes a mattress.
